(19) United States
(12) Patent Application Publication
(10) Pub. No.: US 2023/0274202 A1
(43) Pub. Date: Aug. 31, 2023

(54) ELECTRONIC DEVICE FOR ASSOCIATING STOCK KEEPING UNIT WITH PRODUCT FOR SALE AND METHOD OF THE SAME

(71) Applicant: AX INC., Seoul (KR)

(72) Inventor: Yeonju OH, Seoul (KR)

(73) Assignee: AX INC., Seoul (KR)

(21) Appl. No.: 18/114,969

(22) Filed: Feb. 27, 2023

(30) Foreign Application Priority Data
Feb. 25, 2022 (KR) 10-2022-0025458

(51) Int. Cl. G06Q 10/02; G06Q 10/087

(52) U.S. Cl. CPC G06Q 10/025; G06Q 10/087

(57) ABSTRACT

Proposed is an electronic device including a communication unit configured to exchange data with a plurality of servers, a memory configured to store the data; and a processor configured to perform operations according to commands stored in the memory, wherein the processor generates tour package management units, each having a plurality of attribute fields, determines at least one attribute field among a plurality of attribute fields as a reference attribute field corresponding to each of the servers, groups, for each of the servers, the tour package management units on the basis of the reference attribute field in each of the servers and thus generates a management unit group corresponding to each of the servers, and transmits the management unit group corresponding to each of the servers to each of the servers in such a manner that the servers generate unit tour items corresponding to the management unit group.

### TECHNICAL FIELD

The present disclosure relates to an electronic device for associating a package management unit with a tour package for sale and a method of operating the electronic device.

### BACKGROUND ART

With an increasing demand for a tour, various tour packages have been proposed for sale. Unlike a tour package available in the past that provides accommodation and an airline ticket, current tour packages proposed for sale include various types of tour packages that provide a tour to a specific city, a field trip, a trip for on-the-spot study, and the like. In addition, these tour packages are sold through various sales channels.

The selling of the tour packages through various sales channels provides sellers with the advantage of increasing sales. However, the disadvantage is that the sellers spend much time in managing tour packages registered with a plurality of sales channels and has the difficulty in performing precise management of the tour packages.

This advantage also can be occurred for other types of package.

The matters mentioned above are provided to help understand the background of the present disclosure, and may include relevant matters not disclosed in a document published in the related art.

### SUMMARY OF INVENTION

### Technical Problem

An object of the present disclosure is to provide an electronic device for generating a package management unit to be associated with packages for sale that are managed by a plurality of sales channels and associating the generated package management unit with the tour packages for sale.

### Solution to Problem

According to an aspect of the present disclosure, there is provided an electronic device configured to communicate with a plurality of servers managing unit tour items, the electronic device including: a communication unit configured to exchange data with a plurality of servers; a memory configured to store the data; and a processor configured to perform operations according to commands stored in the memory, wherein the processor generates tour package management units, each having a plurality of attribute fields, determines at least one attribute field among a plurality of attribute fields as a reference attribute field corresponding to each of the plurality of servers, groups, for each of the plurality of servers, the tour package management units on the basis of the reference attribute field in each of the plurality of servers and thus generates a management unit group corresponding to each of the plurality of servers, and transmits the management unit group corresponding to each of the plurality of servers to each of the plurality of servers in such a manner that the plurality of servers generate unit tour items corresponding to the management unit group.

According to another aspect of the present disclosure, there is provided a method of operating an electronic device configured to communicate with a plurality of servers managing unit tour items, the method including: generating tour package management units, each having a plurality of attribute fields; determining at least one attribute field among a plurality of attribute fields, as a reference attribute field corresponding to each of the plurality of servers; grouping, for each of the plurality of servers, the tour package management units on the basis of the reference attribute field and thus generating a management unit group corresponding to each of the plurality of servers, and transmitting the management unit group corresponding to each of the plurality of servers to each of the plurality of servers in such a manner that the plurality of servers generate unit tour items corresponding to the management unit group.

### Advantageous Effects of Invention

The electronic device and the method of generating the electronic device according to the embodiments of the present disclosure are capable of generating a sales management unit and associating the generated sales management unit with tour packages registered with a plurality of sales channels. The effect of this is that a seller can easily manage the tour packages registered with the plurality of sales channels by managing only the sales management unit stored in the electronic device.

### BRIEF DESCRIPTION OF DRAWINGS

FIG. 1 is a block diagram illustrating an electronic device according to an embodiment of the present disclosure.

FIG. 2 is a block diagram illustrating the electronic device according to the embodiment of the present disclosure.

FIG. 3 is a table illustrating data stored in the electronic device according to the embodiment of the present disclosure.

FIG. 4 is a block diagram illustrating a hierarchical structure for attribute fields of the first entity according to the embodiment of the present disclosure.

FIG. 5 is a table that is referred to for description of operation of the electronic device according to the embodiment of the present disclosure.

FIG. 6 is a table that is referred to for the description of the operation of the electronic device according to the embodiment of the present disclosure.

FIG. 7 is a table that is referred to for the description of the operation of the electronic device according to the embodiment of the present disclosure.

FIG. 8 is a table that is referred to for the description of the operation of the electronic device according to the embodiment of the present disclosure.

FIG. 9 is a table that is referred to for the description of the operation of the electronic device according to the embodiment of the present disclosure.

### DESCRIPTION OF EMBODIMENTS

Desired embodiments of the present disclosure will be described in detail below with reference to the accompanying drawings.

The desired embodiments of the present disclosure are provided to enable a person of ordinary skill in the art to get a full understanding of the present disclosure and may be modified in various different forms. However, the scope of the present disclosure is not limited to the desired embodiment. The desired embodiments of the present disclosure are provided to contain sufficient disclosure and to provide a complete understanding of the technical idea of the present disclosure.

Terms that are used in the present specification to describe the desired embodiments of the present disclosure are not intended to impose any limitation on the present disclosure. Unless specially stated otherwise throughout the present specification, a singular noun or a singular noun phrase may have a plural meaning.

When each layer (film), a region, a pattern, or a structure according to the desired embodiment is described as being formed “on” or “under” a substrate, each layer (film), a region, a pad, or a pattern, this means that each layer (film), a region, a pattern, or a structure may be formed “on” a substrate, each layer (film), a region, a pad, or a pattern or “directly” or “with a third layer in between (indirectly),” or “under” a substrate, each layer (film), a region, a pad, or a pattern, “directly” or “with a third layer in between (indirectly).” In addition, a position of a layer before which the preposition “on” or “under” is used is defined with respect to the drawings.

The drawings are provided only for helping get an understanding of the idea of the present disclosure and should not be interpreted as imposing any limitation on the scope of the present disclosure. In addition, for clarity and convenience in description, relative thicknesses or lengths of lines or sizes of constituent elements may be illustrated in non-exact proportion in the drawings.

It would be understandable by a person of ordinary skill in the art that various exemplary blocks, apparatuses, or operations that are described in association with configurations disclosed in the present specification may be implemented as electronic hardware, computer software, or a combination of both. The blocks and apparatuses, or the operations may be implemented or performed using a system of electric circuits, such as a processor, that has an arithmetic operation function. Computer software or a computer program may be stored in a storage medium, such a memory, that is capable of data, and may include a machine-readable command that is executable by the system of electric circuits, such as the processor. An exemplary storage medium may be combined with the processor, and the processor may read information from the storage medium and may record the information in the storage medium. Alternatively, the storage medium may be integrated with the processor.

The desired embodiment of the present disclosure will be described below with reference to the accompanying drawings.

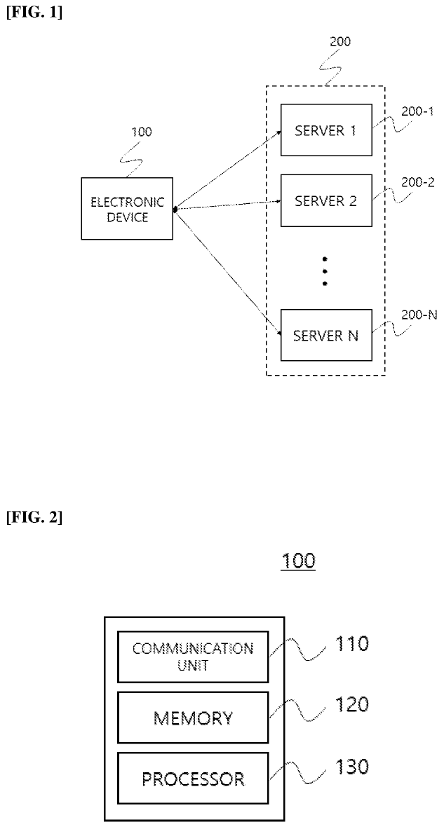

FIG. 1 illustrates an electronic device 100 according to an embodiment of the present disclosure. With reference to FIG. 1, the electronic device 100 may transmit and receive data to and from a plurality of servers 200-1 to 200-N (N is a natural number, and 200-1 to 200-N are collectively referred to as 200).

The servers 200 may each be configured in such a manner as to store data. According to the embodiment, the servers 200 may each host (or manage) a sales page through which a tour package is sold. For example, a purchaser may buy the tour package through the sales page that is hosted by each of the servers 200. At this point, the servers 200 may each store data on the tour package for sale.

The electronic device 100 may exchange data with the servers 200. According to the embodiment, the electronic device 100 may generate and store first data and may associate the stored first data and second data stored in each of the servers 200 with each other. For example, the electronic device 100 may generate the first data corresponding to a package management unit corresponding to a tour package sales unit and may associate the generated first data with the second data corresponding to the tour package stored in each of the servers 200.

The tour package may be sold through various sales channels. That is, the plurality of servers 200 may each store information of the tour package for sale, and purchasers may purchase the tour package through the plurality of servers 200. However, a problem with this process is that a seller spends much time in managing all information on the tour package stored in each of the plurality of servers 200 and may make a mistake in the management. The electronic device 100 according to the embodiment of the present disclosure may generate the first data that corresponds to the package management unit indicating the tour package sales unit and may associate the generated first data with the second data corresponding to the tour package stored (or registered with) in each of the plurality of servers 200. The effect of this is that a user may manage the second data stored in each of the plurality of servers 200 by managing only the first data stored in the electronic device 100. Accordingly, the selling of the tour package through a multiplicity of channels may be easily managed.

FIG. 2 illustrates the electronic device 100 according to the embodiment of the present disclosure. With reference to FIG. 2, the electronic device 100 may include a communication unit 110, a memory 120, and a processor 130.

The communication unit 110 may be configured in such a manner as to exchange data with an external device. According to the embodiment, the communication unit 110 may receive data from a database 200 and the servers 200.

The communication unit 110 may store the received data in the memory 120 under the control of the processor 130.

According to the embodiment, the communication unit 110 may include at least one of a wireless communication circuit coupled to an antenna and a wired communication circuit having a port that is coupled to an external cable, but is not limited thereto.

The memory 120 may be configured in such a manner as to store data associated with operation of the electronic device 100. According to the embodiment, examples of the memory 120 may include a non-volatile memory and a volatile memory.

The processor 130 may control overall operation of the electronic device 100. According to the embodiment, examples of the processor 130 may include a processor that has an arithmetic operation function, and may perform a specific arithmetic operation by executing a plurality of commands.

According to the embodiment, the processor 130 may associate the first data stored in the electronic device 100 with the second data stored in each of the servers 200. Accordingly, the processor 130 may store an identifier for identifying the second data associated with the first data, along with the first data.

According to the embodiment, the processor 130 may receive information on a change in the second data associated with the first data from the servers 200 and may modify the first data associated with the second data on the basis of the information.

According to the embodiment, the processor 130 may transmit a request to perform a specific operation to each of the servers 200.

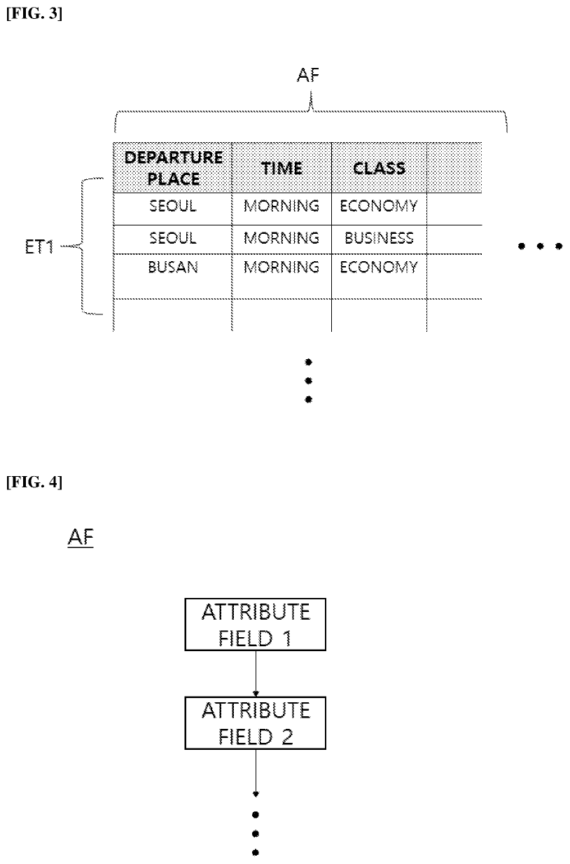

FIG. 3 illustrates data stored in the electronic device 100 according to the embodiment of the present disclosure. With reference to FIG. 3, the electronic device 100 may generate a plurality of first entities ET1 (that is, the first data). The first entities ET1 may be generated by the processor 130 and may be stored in the memory 120.

The first entities ET1 may be data that represent specific objects. According to the embodiment, the first entities ET1 may represent the package management unit indicating the tour package sales unit. When the tour package has attributes (for example, a departure place, time, and the like), each unit that is determined according to each attribute value is referred to as a tour package management unit.

The first entities ET1 may each have an attribute field AF. A plurality of attribute fields AF may be provided. The attribute fields AF serves to define each of the first entities ET1, and are assigned attribute values, respectively. For example, in a case where the first entities ET1 represent the package management unit for the tour package, the attribute fields AF represent a departure date, departure time, a departure place, a destination place, an age category, a price, and the like, respectively, but are not limited thereto. The first entities ET1 may each be defined by the attribute fields ATT.

The electronic device 100 may generate the first entities ET1 by generating a plurality of attribute fields and determining an attribute value of each of the plurality of attribute fields.

According to the embodiment, the electronic device 100 may generate the first entities ET1 by determining the attribute value of each of the plurality of attribute fields on the basis of data input from the outside. For example, the user may input data for generating the first entities ET1 through the electronic device 100.

According to the embodiment, by accessing an external database and then using data stored in the external database, the electronic device 100 may determine the attribute value of each of the plurality of attribute fields and may generate the first entities ET1. For example, in the case where the first entities ET1 represent the package management unit for the tour package, the electronic device 100 may access the database in which the information on the tour package is stored and may generate the first entities ET1. For example, the electronic device 100 may generate the first entities ET1 by accessing the database linked to a tour package sales web page onto which the tour package is uploaded.

FIG. 4 illustrates a hierarchical structure for attribute fields AF of the first entity according to the embodiment of the present disclosure. With reference to FIG. 4, the attribute fields AF may have a hierarchical structure. The attribute fields AF may contain attribute fields in different hierarchies. For example, as illustrated in FIG. 4, the first attribute field may be in a higher hierarchy than a second attribute field. For example, in a case where the entities are associated with the tour package, a date for the tour package may correspond to an attribute field in a high-level hierarchy, and the time may correspond to an attribute field in a low-level hierarchy.

According to the embodiment, the attribute fields in the low-level hierarchy may be grouped into attribute fields in the high-level hierarchy.

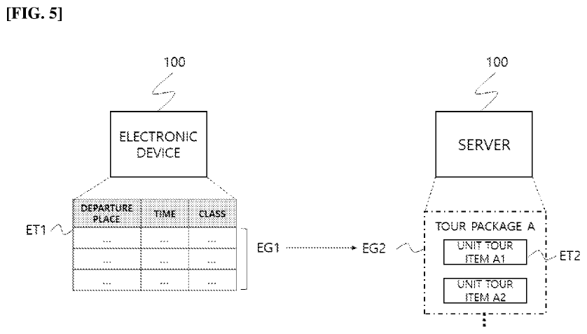

FIG. 5 is a table that is referred to for description of operation of the electronic device 100 according to the embodiment of the present disclosure. For convenience, the electronic device 100 according to the embodiment of the present disclosure is described on the assumption that one server 200 is typically provided. However, of course, the electronic device 100 may find application in the plurality of servers 200.

With reference to FIG. 5, the electronic device 100 may output a request to generate second entities ET2 that correspond to the first entities ET1, respectively. The request that is output may be transmitted to the server 200. In response to the request, the server 200 may generate the second entities ET2. The second entities ET2 generated by the server 200 may be associated with the first entities ET1, respectively, in the electronic device 100.

The server 200 may generate the second entities ET2 and may store the generated second entities ET2. In addition, the server 200 may generate a second entity group EG2 that contains the second entities ET2.

The second entity group EG2 may represent the tour packages that are sold (or managed) through the server 200. The second entities ET2 contained in the second entity group EG2 may represent unit tour items, respectively, that constitute the tour package. For example, the second entity group EG2 may represent a tour package designating that the departure place is “Seoul,” the destination place is “Busan,” and the departure time is “Morning.” The second entities ET2 contained in the second entity group EG2 may represent a unit tour item designating that the seat class is “Economy” and a unit tour item designating that the seat class is “Business,” respectively.

At this point, although the tour packages are the same, the number of unit tour items may vary among the servers 200. The reason for this is because, for example, a tour package that indicates the seat class, “Economy” or “Business” may be sold through one server and a tour package that does not indicate the seat class, “Economy” or “Business” may be sold through another server.

The second entities ET2 may contain identifiers for identifying the second entities ET2. According to the embodiment, some of the second entities ET2 may contain the same identifier. In this case, it can be understood that the second entities ET2 containing the same identifier form one group.

Using an application programming interface (API) of the server 200, the electronic device 100 may control the server 200 in such a manner that the server 200 generates the second entities ET2. At this point, the electronic device 100 may transmit a request to generate the second entities ET2, along with information on the first entities ET1, to the server 200, and the server 200 may generate the second entities ET2 on the basis of the received information and request.

At this point, the electronic device 100 may group the first entities ET1 to form the first entity group EG1 and may transmit to the server 200 a request to generate the second entity group EG2 containing the second entities ET2 corresponding to the first entities in the first entity group EG1.

The first entities ET1 represent the package management unit indicating the tour package sales unit. Therefore, the electronic device 100 may make the stored first entities ET1 correspond to the second entities ET2, respectively, that represent the unit tour items in the server 200. At this point, a collection of the unit tour items represents one tour package. Therefore, the electronic device 100 may group the first entities ET1 in such a manner as to represent unit tour items of one tour package. The first entity group EG1, resulting from the grouping, corresponds to the second entity group EG2 representing one tour package in the server 200. At this point, the second entity group EG2 corresponding to the first entity group EG1 may have the same identifier (for example, 1 in FIG. 5).

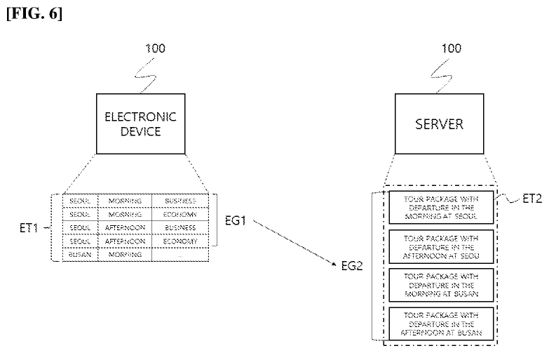

FIG. 6 is a table that is referred to for the description of the operation of the electronic device 100 according to the embodiment of the present disclosure. With reference to FIG. 6, the first entities ET1 stored in the electronic device 100 and the second entities ET2 stored in the server 200 may be associated with each other.

According to the embodiment, the second entities ET2 may correspond to the tour packages that are sold (or managed) through the server 200. According to the embodiment, the second entities ET2 may each have an attribute field, and the attribute field may represent attributes of the tour packages. For example, a “Tour Package with Departure in the Morning at Seoul” in FIG. 6 may contain an attribute field containing the departure (“Seoul”) and the departure time (“Morning”).

The tour package may have a plurality of attributes. In other words, the tour package may be configured to contain a plurality of unit tour items that have specific attributes, respectively. For example, the tour packages may each have attributes, such as the date, the departure place, the destination place, the time, and the seat class. In this case, the attributes may each have a multiplicity of values. Therefore, the tour package is configured to contain the plurality of unit tour items. For example, a page for purchasing the tour package may be provided by the server 200. The plurality of unit tour items may be selected from the page by selecting an attribute of the tour package therefrom. For example, the purchaser may select (or purchase) the plurality of unit tour items from the page from which one tour package may be purchased, by selecting attribute values therefrom.

Accordingly, the second entities ET2 stored in the server 200 may each correspond to the unit tour items that constitute the tour package, and a group of the second entities ET2 may correspond to one tour package containing unit tour items. The group of the second entities ET2 that corresponds to one tour package may contain an identifier (for example, an identifier (ID) of the tour package, an address of the page from which the tour package is sold, or the like) for identifying the one tour package.

For example, the electronic device 100 may transmit to the server 200 a request to generate the second entity group EG2 corresponding to the first entity group EG1 that represents a tour package designating that the departure place is “Seoul.” At this point, the electronic device 100 may transmit to the server 200 information (for example, respective values of the attribute fields, and the like) on the first entity group EG1, along with the request.

In response to the request, the server 200 may generate the second entities ET2 corresponding to the first entity group EG1 and may form the second entity group EG2 by grouping the generated second entities ET2. For example, the server 200 may generate the second entities ET2 designating the unit tour items, “Departure in the Morning at Seoul” and “Departure in the Evening at Seoul” and may group the generated second entities ET2 to form the second entity group EG2.

According to the embodiment, the second entities ET2 in the second entity group EG2 may contain the same identifier. The identifier, as an identifier that is managed by the server 200, may be, for example, an identifier of the tour package (or the sales page for the tour package) that is sold through the server 200. For example, the second entities ET2 in the second entity group EG2 may contain the same tour package ID that identities the tour package designating that the departure place is “Seoul.”

The electronic device 100 may associate the first entity group EG1 and the second entity group EG2 corresponding to the first entity group EG1 with each other. According to the embodiment, the electronic device 100 may associate the first entities ET1 in the first entity group EG1 and the second entities ET2 in the second entity group EG2 with each other.

When the first entity and the second entity are described as being associated with each other in the present specification, this means that the electronic device 100 identifies the second entity using information on the first entity or that, in contrast, the electronic device 100 keeps the first entity identifiable using information on the second entity. For example, the electronic device 100 may additionally store an identifier for identifying the second entity associated with the first entity.

According to the embodiment, the electronic device 100 may associate the first entity ET1 and the second entity (ET2) with each other on the basis of the attribute field. The electronic device 100 may associate the second entity ET2 and the first entity ET1, having the attribute field containing the attribute field of the second entity ET2, with each other. For example, the electronic device 100 may associate the first entity designating that the departure place is “Seoul,” the departure time is “Morning,” and the seat class is “Business,” with the second entity that represents the unit tour item designating “Departure in the Morning at Seoul.”

Alternatively, according to the embodiment, the electronic device 100 may associate the first entity and the second entity, which represent the same tour package, with each other. For example, the electronic device 100 may receive information on the same identifier that the second entities ET2 in the second entity group EG2 in the server 200 have, and may store the same identifier in association with the first entities ET1 in the first entity group EG1. For example, the identifier may be a tour package ID of the tour package that is represented by the second entities ET2.

That is, the electronic device 100 may reflect information, corresponding to the second entity group EG2 in the server 200, in the first entity group EG1. As a result, the user may manage the second entity group EG2 in the server 200 through the first entity group EG1 in the electronic device 100.

According to the embodiment, the electronic device 100 may receive information on the amount of sales of the tour packages (and the unit tour items contained in the tour packages) corresponding to the second entity group EG2, using the identifier stored in the server 200 in association with the first entity group EG1, and may reflect the received information on the amount of sales in the inventory of the first entities ET1 in the first entity group EG1. Particularly, as described above, although the tour packages containing the same attributes are sold through the plurality of servers 200, the seller may integrally manage the tour packages that are sold through the plurality of servers 200, through the entity group stored in the electronic device 100.

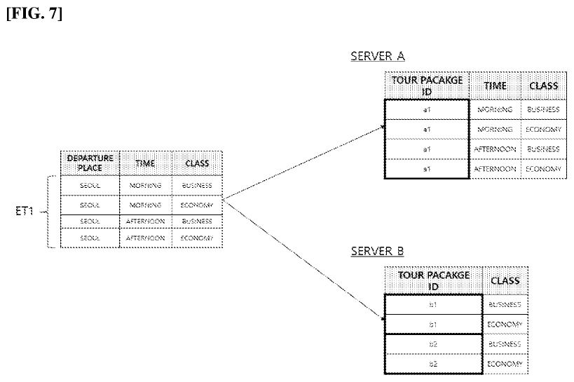

FIG. 7 is a table that is referred to for the description of the operation of the electronic device 100 according to the embodiment of the present disclosure. FIG. 7 illustrates the second entities stored in the servers 200.

The unit tour items contained in the tour packages that are provided by the servers 200 may have different hierarchical structures. The reason for this is because the second entities stored in the servers 200 have the different numbers of attribute fields. The number of attribute fields that is to be considered here may be the number of attribute fields associated with the tour package that is represented by the entity. For example, the second entities stored in a server A may have two attribute fields (the departure time and the seat class), but the second entities stored in a server B may have one attribute field (the seat class). Due to this difference, the unit tour item contained in one tour package may vary in hierarchical structure.

For example, it is assumed that the first entities ET1 are present which correspond to a tour package designating that the departure place is “Seoul,” the departure time is “Morning,” and the seat class is “Business,” a tour package designating that the departure place is “Seoul,” the departure time is “Afternoon,” and the seat class is “Business,” a tour package designating that the departure place is “Seoul,” the departure time is “Morning,” and the seat class is “Economy,” and a tour package designating that the departure place is “Seoul,” the departure time is “Afternoon,” and the seat class is “Economy.” At this point, the number of first entities ET1 is 4 (2×2).

In the case of the server A, the second entities each contain two attribute fields (the departure time and the seat class). Therefore, only with one second entity group, the first entities (ET1) may be represented. That is, the first entities ET1 may correspond to one second entity group in the server A. For example, under the control of the electronic device 200, the server A may generate and store one second entity group EG2 that corresponds to the first entities ET1 and has the same tour package ID that is “a1.” That is, the server A may generate one tour package (having the tour package ID a1) corresponding to the first entity group EG1. In this case, the tour package contains four unit tour items.

In the case of the server B, the second entities each contain one attribute field (the seat class). Therefore, the first entity group EG1 cannot be represented by one second entity group EG2. That is, the first entities (ET1) may correspond to two second entity group EG2 in the server B. That is, in the case of the server B, one tour package may be represented through at least two entity groups. For example, the server B may generate the second entity group EG2 that corresponds to the first entities ET1, in the first entity group EG1, which designates that the departure time is “Morning,” and has the same tour package ID that is “b1,” and the second entity group EG2 that corresponds to the first entities ET1 designating that the departure time is “Afternoon” and has the same tour package ID that is “b2.” That is, the server B may generate two tour packages (having the tour package IDs b1 and b2) corresponding to the first entity group EG1. In this case, each of the tour packages contains two unit tour items.

The electronic device 100 according to the embodiment of the present disclosure may form the first entity group EG1 by grouping at least some of the first entities ET1, and may transmit a request to generate the second entities ET2 corresponding to the first entity group EG1 to the server 200. At this time, the second entities ET2 corresponding to the first entity group may be generated in such a manner as to have the same identifier.

The electronic device 100 may group the first entities ET1 on the basis of a reference attribute field. According to the embodiment, for each of the servers 200, the electronic device 100 may group the first entities ET1 on the basis of the predetermined reference attribute field. The reference attribute field is determined to each of the servers 200. For example, the reference attribute field is a value (or information) that corresponds to each of the servers 200. The electronic device 100 may store information on the reference attribute field in each of the servers 200.

The reference attribute field may contain a value that is determined according to a hierarchical structure for the attribute fields of the second entities ET2 in the servers 200. The reference attribute field for each of the servers 200 may be an attribute field that is in a higher hierarchy than an attribute field in the highest hierarchy, among attribute fields contained in the second entities ET2 in each of the severs 200. According to the embodiment, for example, for the server A, the electronic device 100 may group the first entities ET1 according to a departure attribute field and, for the server B, may group the first entities ET1 according to a time attribute field.

According to the embodiment, at least two servers of the servers 200 may have different reference attribute fields.

In a case where the reference attribute fields in the two servers 200 are different from each other, for the two servers 200, the electronic device 100 may form different first entity groups EG1, respectively. For example, for the server A, the electronic device 100 transmit to the server A a request to form the first entity group EG1 that contains all first entities ET1 and to generate the second entities ET2 corresponding to the first entity group. The server A may generate one second entity group that corresponds to the first entity group EG1 and has the same tour package ID that is “a1.” Accordingly, all the first entities ET1 are associated with one second entity group EG2 that has the same tour package ID that is “a1.”

In contrast, for the server B, the electronic device 100 may form the first entity group EG1 containing some of the first entities ET1. For example, the electronic device 100 forms two first entity groups EG1 from the first entities ET1 and transmits to the server B a request to generate the second entities ET2 corresponding to the formed two first entity groups EG1, respectively. The server B may generate two second entity groups EG2 that correspond to the first entity groups EG1, respectively, and have the same tour package ID that is “b1” and the same tour package ID that is “b2,” respectively. Accordingly, the first entities ET1 may be associated with two second entity groups EG2, respectively, that have the same tour package ID that is “b1” and the same tour package ID that is “b2,” respectively.

For each of the servers 200, the electronic device 100 according to the embodiment may group the first entities ET1 on the basis of the reference attribute field that is determined for each of the servers 200 and may transmit to the server 200 a request to generate the second entities ET2 corresponding to the first entities ET1, respectively, that result from the grouping. Accordingly, the first entities ET1 may be grouped in a manner that is consistent with a hierarchical structure supported by each of the servers 200.

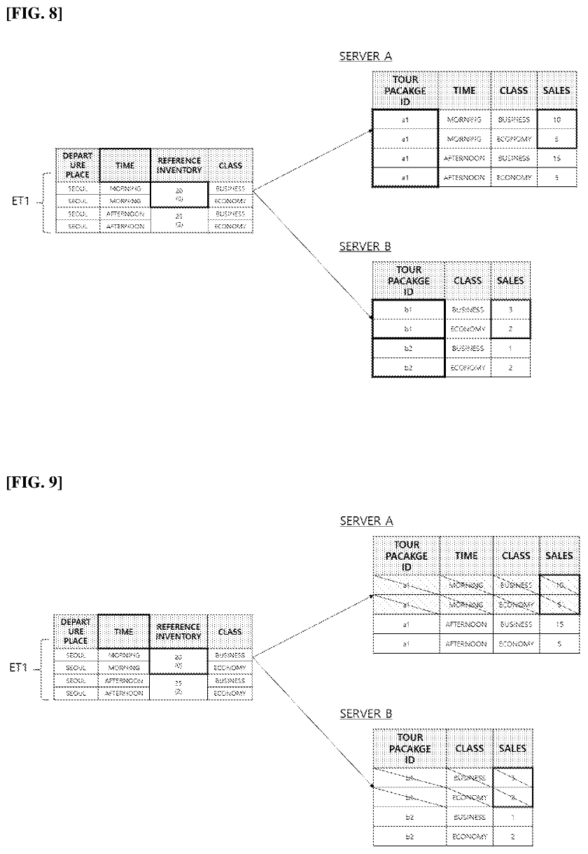

FIG. 8 is a table that is referred to for the description of the operation of the electronic device 100 according to the embodiment of the present disclosure. With reference to FIG. 8, in a case where the entities represents the tour package, the electronic device 100 may receive sales information associated with the tour packages in each of the servers 200 and may collate the sales information.

As described above, the first entity group EG1 in the electronic device 100 and the second entity group EG2 in the server 200 may be stored in such a manner as to be associated with each other. At this point, the server 200 may store the amount of sales of the unit tour items represented by the second entities ET2 in the second entity group EG2 in association with each of the second entities ET2 in the second entity group EG2. Alternatively, information on the amount of sales may also be stored in a manner that is contained in the second entity ET2.

The electronic device 100 may receive information on the amount of sales of the unit tour items (that is, the second entities ET2) in each of the servers 200 from each of the servers 200. According to the embodiment, the electronic device 100 may identify the second entity group EG2 stored in association with the first entity group EG1, from data stored in the server 200 and may refer to the amount of sales of each of the second entities ET2 in the second entity group EG2.

The electronic device 100 may determine an inventory of the package management unit by collating the amounts of sales of the unit tour items in the plurality of servers 200. According to the embodiment, the electronic device 100 may collate the amounts of sales of the second entity groups EG2 in the servers 200 that correspond to the first entity group EG1. For example, one package management unit (that is, one first entity) corresponds to the unit tour item (that is, the second entity) in the plurality of servers 200. Therefore, the electronic device 100 may determine the amount of sales of one package management unit (that is, one first entity) as the sum of the amounts of sales of the corresponding unit tour item (the second entity) in the plurality of severs 200, and thus may determine the inventory of the package management unit by comparing the amount of sales of the tour package management units with a reference inventory of the tour package management unit.

According to the embodiment, the electronic device 100 may determine the inventory on the basis of each attribute field unit of the tour package management unit. According to the embodiment, the electronic device 100 may determine an attribute field (that is, an inventory reference field) that is a target of inventory management, among the attribute fields of the package management unit and may determine a reference inventory value corresponding to the determined inventory reference field. Then, the electronic device 100 may collate the amounts of sales of the unit tour items, which are transmitted from the servers 200, on the basis of the inventory reference field and may compare the collated amounts of sales with the reference inventory value.

As illustrated in FIG. 8, the electronic device 100 may receive information on the amounts of sales of the unit tour items in the server A and the server B. The electronic device 100 may collate the amounts of sales the unit tour items on the basis of the inventory reference field. For example, the inventory reference field may be “time,” and the electronic device 100 may collate the amounts of sales on the basis of the “time” attribute field. As a result of the collation, the electronic device 100 may determine that the amount of sales of the unit tour items designating that (the departure is “Seoul”) and the time is “Morning” is “20” and that the amount of sales of the unit tour items designating that the time is “Afternoon” is “23”).

The electronic device 100 may determine the reference inventory value corresponding to the “time” attribute field that is the determined inventory reference field. At this point, the reference inventory value may be determined on the basis of each attribute value corresponding to the attribute field. For example, the electronic device 100 may determine that the reference inventory value corresponding to the time “Morning” is “20” and that the reference inventory value corresponding to the time “Afternoon” is “25.”

The electronic device 100 may compare the collated amounts of sales of the unit tour items with the reference inventory value and may compute a level of inventory according to a result of the comparison. For example, it is assumed that the amount of sales of the unit tour items in the server A in a case where the time is “Morning” is “15,” that the amount of sales of the unit tour items in the server B is “5,” and that the reference inventory in a case where the time is “Morning” is “20.” Under this assumption, the electronic device 100 may determine that a level of inventory of the unit tour items in a case where the time is “Morning” is “0.”

According to the embodiment, the electronic device 100 may receive and collate the amounts of sales of the unit tour items in the plurality of servers 200 and may compute the inventory of the unit tour items on the basis of each inventory reference field. Although the servers 200 have different hierarchical structures, the seller may know the inventory on the basis of the designated inventory reference field, and thus may easily manage an inventory of the tour packages for sale.

FIG. 9 is a table that is referred to for the description of the operation of the electronic device according to the embodiment of the present disclosure. With reference to FIG. 9, the electronic device 100 may compare the amounts of sales of the unit tour items, which are collated on the basis of the inventory reference field, with a predetermined reference inventory, and may transmit a request associated with tour package selling to each of the servers 200.

According to the embodiment, in a case where the collated amounts of sales reaches the reference inventory, the electronic device 100 may transmit a request to stop the selling of the unit tour item, corresponding to the collated amounts of sales, to the servers 200 through which the unit tour item is sold. For example, as illustrated in FIG. 9, the electronic device 100 may determine that the amount of sales of the unit tour items designating that the time is “Morning” reaches 20 that is the reference inventory value. Accordingly, the electronic device 100 may transmit a request to stop the selling of the corresponding unit tour items to both the server A and the server B. In response to the request, the servers A and B may perform a setting in such a manner that the purchasers do not place an order for the unit tour items designating that the time is “Morning.” For example, the server A and the server B may perform a setting in such a manner that the purchasers making a connection to the tour package page cannot place an order for the unit tour items designating that the time is “Morning.”

According to the embodiment of the present disclosure, the electronic device 100 may collate the amounts of sales of the unit tour items in the plurality of servers 200 and manage the inventory on the basis of the inventory reference field. Moreover, the electronic device 100 may transmit a request to apply the level of the inventory to all the servers 200 through which the corresponding unit tour items are sold. Therefore, the tour packages that are sold through each of the servers 200 can be easily managed.

However, the technical idea of the present disclosure is described above only in an exemplary manner. Although the present disclosure is described on tour package, the technical idea or features of the present disclosure is also be applied to other kinds (or types) of packages that have plurality of attributes.

It is apparent to a person of ordinary skill in the art to which the present disclosure pertains that various alterations and modifications are possibly made to the embodiments of the present disclosure without departing from the nature and gist of the present disclosure. Therefore, the embodiments of the present disclosure that are disclosed in the present specification are for describing, rather than limiting, the technical idea of the present disclosure and do not impose any limitation on the scope of the technical idea of the present disclosure. Accordingly, the scope of protection of the present disclosure should be defined by the following claims. All technical ideas that fall within the scope equivalent thereto should be interpreted to be included within the scope of the claims of the present disclosure.

1. An electronic device configured to communicate with a plurality of servers managing unit tour items, the electronic device comprising:
a communication unit configured to exchange data with a plurality of servers;
a memory configured to store the data; and
a processor configured to perform operations according to commands stored in the memory,
wherein the processor generates tour package management units, each having a plurality of attribute fields,
determines at least one attribute field among a plurality of attribute fields as a reference attribute field corresponding to each of the plurality of servers,
groups, for each of the plurality of servers, the tour package management units on the basis of the reference attribute field in each of the plurality of servers and thus generates a management unit group corresponding to each of the plurality of servers, and
transmits the management unit group corresponding to each of the plurality of servers to each of the plurality of servers in such a manner that the plurality of servers generate unit tour items corresponding to the management unit group.

2. The electronic device of claim 1, wherein the package management unit in the electronic device and the unit tour items in the plurality of servers are associated with a tour.

3. The electronic device of claim 1, wherein the plurality of attribute fields have a hierarchical structure, and
wherein the reference attribute field for each of the plurality of servers is an attribute field that is in a higher hierarchy than an attribute field in the highest hierarchy, among the attribute fields contained in the unit tour items in each of the plurality of servers.

4. The electronic device of claim 1, wherein the unit tour items that are generated by each of the servers and correspond to the management unit group contain the same identifier, and
wherein the processor receives the same identifier from each of the servers and stores the received same identifier in association with the corresponding management unit group.

5. The electronic device of claim 1, wherein the reference attribute fields in at least two servers among the servers have different hierarchies, and
wherein the processor generates the management unit group in such a manner that the management unit groups that correspond to the at least two servers, respectively, among the servers, contain the different numbers of the tour package management units.

6. The electronic device of claim 1, wherein the processor determines any one of the attribute fields of the package management unit as an inventory reference field, receives information on an amount of sales of the unit tour items from each of the servers, and collates and stores the amounts of sales of the unit four items in each of the servers on the basis of the inventory reference field.

7. The electronic device of claim 6, wherein the processor determines a reference inventory value corresponding to the inventory reference field, compares the collated amounts of sales with the reference inventory value, and, when the collated amounts of sales reaches the reference inventory value, outputs a request to stop each of the plurality of severs from selling the corresponding unit tour items.

8. A method of operating an electronic device configured to communicate with a plurality of servers managing unit tour items, the method comprising:
generating tour package management units, each having a plurality of attribute fields;
determining at least one attribute field among a plurality of attribute fields, as a reference attribute field corresponding to each of the plurality of servers;
grouping, for each of the plurality of servers, the tour package management units on the basis of the reference attribute field and thus generating a management unit group corresponding to each of the plurality of servers; and
transmitting the management unit group corresponding to each of the plurality of servers to each of the plurality of servers in such a manner that the plurality of servers generate unit tour items corresponding to the management unit group.

9. The method of claim 8, further comprising:
determining any one of the attribute fields of the package management unit as an inventory reference field;
receiving information on an amount of sales of the unit tour items from each of the servers; and
collating and storing the amounts of sales of the unit tour items in each of the servers on the basis of the inventory reference field.

10. The method of claim 9, further comprising:
determining a reference inventory value corresponding to the inventory reference field; and
comparing the collated amounts of sales with the reference inventory value, and, when the collated amounts of sales reaches the reference inventory value, outputting a request to stop each of the plurality of severs from selling the corresponding unit tour items to each of the plurality of servers.
